(19) United States
(12) Patent Application Publication
(10) Pub. No.: US 2003/0018916 A1
(43) Pub. Date: Jan. 23, 2003

(54) Secure remote access service delivery system

(75) Inventors: James Anthony Smith, Prior Lake, MN (US); Her Moua, Prior Lake, MN (US); Scott Dale Roswold, Batavia, IL (US)

Correspondence Address: Schwegman, Lundberg, Woessner & Kluth, P.A., P.O. Box 2938, Minneapolis, MN, 55402, US

(73) Assignee: RemotePipes, Inc.

(21) Appl. No.: 09/909,669

(22) Filed: Jul. 20, 2001

(51) Int. Cl. H04L 9/00

(52) U.S. Cl. 713/201; 713/150

(57) ABSTRACT

A method of providing secure dial-in access to an enterprise system over a public network via a Virtual Secure Point of Presence (VSPOP) is provided. A dial-in user connection is received in a VSPOP, and the user connection is authenticated. The VSPOP provides an encrypted connection from the received dial-in connection in the VSPOP to the enterprise system over a public network.

### FIELD OF THE INVENTION

The invention relates generally to computer network access via telephone, and more specifically to a system providing secure remote access to a computer system over a public network via a telephone dial-in connection.

### BACKGROUND OF THE INVENTION

As computers have become more heavily relied upon to facilitate the day-today operations of all types of businesses, the need to have these computers communicate with each other to exchange information has become increasingly important. Communication of data via paper copies of records or even via data stored on machine-readable media such as tape, punch card, or diskette has largely been replaced with the more immediate communication method of computer networking, enabling real-time request and communication of data.

Local area computer networks are commonly employed within business locations to facilitate communication between computers within a particular business site, and are often supplemented by wide area networks that link the local area networks of multiple sites or locations within a particular business organization. These networks enable centralized record keeping, real-time e-mail and other communication between computer users, and a variety of other data exchange functions within the relatively secure network system owned and operated by the business organization.

But, as the Internet has become increasingly common as a means of communication, the desirability of connecting a business organization's local area network or wide area network to the Internet for e-mail, information retrieval, and other communication has led many relatively secure business networks to establish Internet connections. These connections to the Internet are typically protected by a firewall and by other common security measures designed to prevent unauthorized Internet users from accessing the business organization's private network, and sometimes further restricting the business organization's computer users access or use of the Internet.

Intentional communication of a business organization's confidential information over the Internet remains problematic, though, because such information will typically travel in an insecure form through a number of computer systems not owned or controlled by the sending business organization or intended recipient. Encryption is often employed to prevent interception of confidential information over the Internet, but requires coordination of the sender and receiver's special-purpose hardware or software to facilitate the encryption and subsequent decryption of the transmitted information.

Such encryption software or hardware requires not only employing the additional software or hardware while communicating confidential information, but requires purchasing the software or hardware as well as configuration and support of the encryption system. Remote computer system user such as dial-in users who dial in to an Internet service provider and access business organization records through the Internet therefore would need to have an encryption system installed and configured on their remote computer that is coordinated with an encryption system on the business organization system.

One alternate system that provides a relatively secure connection between multiple remote users and an enterprise system is a dial-in system, in which each user establishes a dial-in connection to a remote access system (RAS) device directly connected to the enterprise system. Because no data travels over a public network such as the Internet, there is little risk that sensitive data will be intercepted. But, such systems also require configuration of a RAS device and associated equipment, telephone line connections and long-distance charges, and trained support staff to provide the dial-in connection service.

Because there is significant expense in installing and maintaining these encryption or dial-in systems, it is desirable to provide a secure method for dial-in users to communicate securely with their business organization computers via the Internet or other public network without requiring special-purpose encryption capability to be installed and configured on every remote dial-in system, and without requiring an enterprise system to maintain and fund a long-distance dial-in system.

### SUMMARY OF THE INVENTION

The present invention provides a method of providing secure dial-in access to an enterprise system over a public network via a Virtual Secure Point of Presence (VSPOP). A dial-in user connection is received in a VSPOP, and the user connection is authenticated. The VSPOP provides an encrypted connection from the received dial-in connection in the VSPOP to the enterprise system over a public network.

### BRIEF DESCRIPTION OF THE FIGURES

FIG. 1 shows a block diagram of a virtual secure point of presence as may be used to practice an embodiment of the present invention.

FIG. 2 is a flowchart, illustrating a method of practicing an embodiment of the present invention.

### DETAILED DESCRIPTION

In the following detailed description of sample embodiments of the invention, reference is made to the accompanying drawings which form a part hereof, and in which is shown by way of illustration specific sample embodiments in which the invention may be practiced. These embodiments are described in sufficient detail to enable those skilled in the art to practice the invention, and it is to be understood that other embodiments may be utilized and that logical, mechanical, electrical, and other changes may be made without departing from the spirit or scope of the present invention. The following detailed description is, therefore, not to be taken in a limiting sense, and the scope of the invention is defined only by the appended claims.

The present invention provides a secure method for dial-in users to communicate securely with their business organization computers via the Internet or other public network without requiring special-purpose encryption capability to be installed and configured on every remote dial-in system, and without requiring an enterprise system to maintain and fund a long-distance dial-in system. The present invention provides a method of providing secure dial-in access to an enterprise system over a public network via a Virtual Secure Point of Presence (VSPOP). A dial-in user connection is received in a VSPOP, and the user connection is authenticated. The VSPOP provides an encrypted connection from the received dial-in connection in the VSPOP to the enterprise system over a public network.

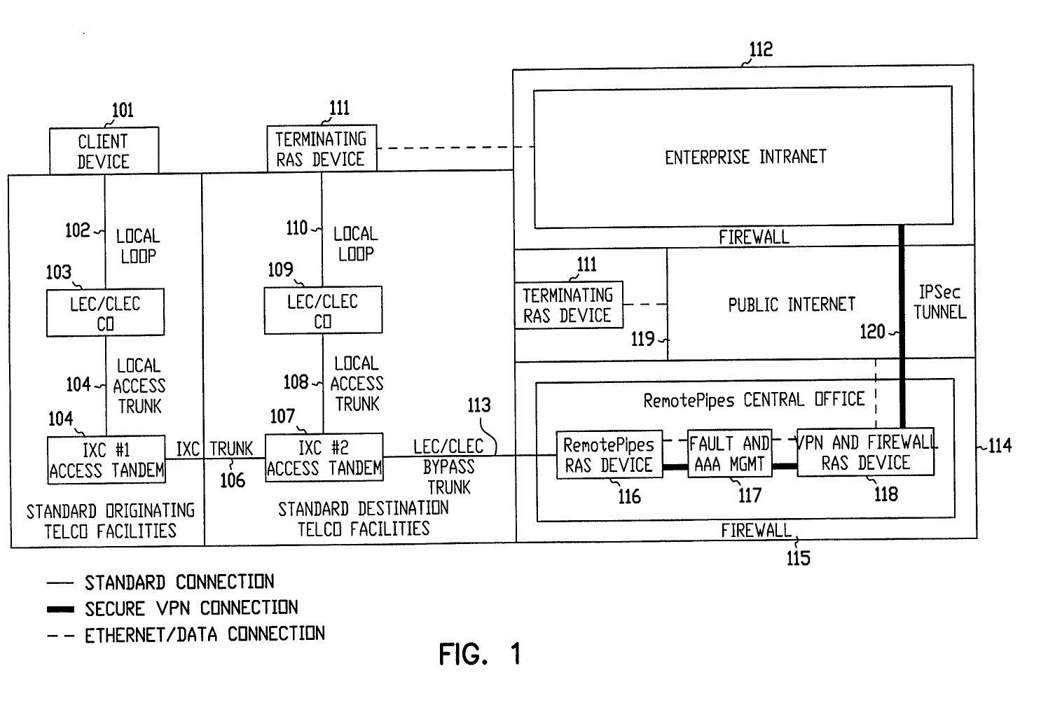

FIG. 1 shows a block diagram of a virtual secure point of presence as may be used to practice an embodiment of the present invention. A client device 101 is connected via a local loop dial-in connection 102 to a local exchange company (LEC) 103. The LEC equipment is connected via a local access trunk 104 to an interexchange carrier (IXC) access tandem 105, which routes the dial-in connection via interexchange carrier trunks 106 to other interexchange carrier access tandems as appropriate, until the connection reaches a destination interexchange carrier access tandem 107.

In making traditional telephone calls, the call is routed from the interexchange carrier access tandem 107 vial local access trunk 108 to a local exchange company 109, which directs the call via a local loop 110 to a terminating RAS device 111. This terminating RAS device is typically a modem in computer communication applications, which is connected to the destination computer at 112 either directly through a private network or via a public switched network such as the Internet at 119.

Such a phone connection incurs significant cost at the local equipment company on each side of the connection, as well as at the interexchange carrier trunk level. Also, the terminating RAS device and the connection between the terminating RAS device and the destination computer system must be maintained and managed at some expense. One option is for a company or other organization to maintain a modem bank with supporting computer equipment and staff that enable receipt of calls via the modem 111 and authenticate users before connecting them to the destination computer at 112. Alternatively, such an organization can make use of a dial-in service which maintains modems for dial-in access, and that then provides a connection via a public network such as the Internet 119 to the destination computer 112. Both options involve paying long distance phone charges through a remote or destination local exchange company (LEC), and require extensive staff and equipment to provide a secure connection over a public network or to operate a phone bank.

Also, the client device 101 typically must have some type of encryption software installed and configured to support secure communication over a public network 119, which adds software and support expense to the dial-in client as well as to the destination. The present invention addresses some of these problems and other problems, and provides secure dial-in access to an enterprise system over a public network via a Virtual Secure Point of Presence (VSPOP).

One embodiment of the present invention incorporates a VSPOP shown generally at 114, which receives dial-in telephone calls from the destination interexchange access tandem 107 via a bypass trunk 113 rather than through a local exchange company. This reduces the cost associated with the phone call by eliminating the destination local exchange company fee from the dial-in cost.

The phone calls are then received in the VSPOP via a RAS device 116, which in various embodiments provides fault management and authentication, accounting, and authorization (AAA) management at 117 within the VSPOP. The VSPOP further provides a secure connection over the public switched network 119, via technology such as virtual private network (VPN) 118 and tunneling systems 120. Also, the VSPOP of some embodiments has a firewall 118, preventing unauthorized access from the public network 119 to the VSPOP.

Such a system reduces the cost associated with the dial-in telephone connection, eliminates the need for client-based encryption software or configuration, and provides a secure connection via a public network such as the Internet to the destination system 112. Because the dial-in connection from the client device to the VSPOP is as secure as any telephone call, the client company wanting to provide secure access to the destination system need only provide user authentication and tunneling support for one Internet connection in such a system

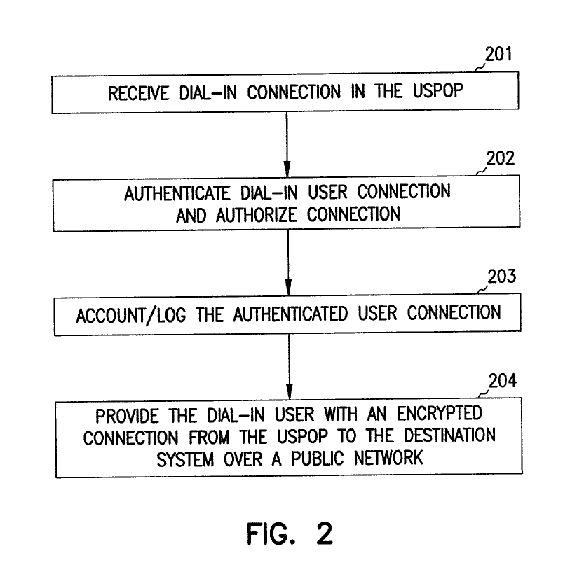

FIG. 2 is a flowchart illustrating a method of providing secure access via a VSPOP as illustrated and discussed in conjucntion with FIG. 1. At 201, the dial-in connection from a dial-in user is received in the virtual secure point of presence (VSPOP). The dial-in connection may be received via a local exchange company bypass trunk as shown at 113 in FIG. 1, and is in some embodiments a toll-free dial in connection not requiring long distance charges for the dial-in user.

The received phone call enables the client device to establish communication with an LNS (L2TP Network Server) device via PPP, SLIP, or another dial-in connection protocol. The connection need not be encrypted between modems because a normal telephone connection is already quite secure relative to Internet or other public network connections, but may be encrypted in some embodiments to provide further security. The data remains secure in the VSPOP by nature of its communication via L2TP or other tunneling protocol in select embodiments of the invention. This will help prevent clients dialed in to the same VSPOP subnet or access pool from being able to access other dial-in user's data.

The dial-in user connection is authenticated at 202, which enables connection between the dial-in user and the destination computer system. Authentication can be achieved in any number of ways, such as by using a user authentication service provided by the VSPOP. Such a VSPOP-based authentication service can be provided by a standard Remote Authentication Dial-In User Service (RADIUS) system local to the VSPOP, or any other such suitable authentication system. The local RADIUS server could then be updated by a remote SSL connection or other RADIUS configuration tool to keep authentication records up to date. In some alternate embodiments of the invention, the authentication is facilitated by a system that includes the destination computer system, such as an enterprise RADIUS server that communicates authentication information with the VSPOP via an LNS (L2TP Network Server) or other similar protocols.

At 203, an account log is created for the authenticated user connection. The account log can be used in various embodiments of the invention for tracking such things as billing, quality of service monitoring, security analysis, and other such operational characteristics.

The dial-in user is provided an encrypted connection over a public network from the VSPOP to the destination enterprise system at 204. The encrypted connection in various embodiments will be a PPTP connection, an L2F (Layer 2 Forwardng) connection, an IPSec connection, or any other suitable type of tunneled or encrypted connection.

The encrypted connection provides security for the information passing over a public network such as the Internet between the destination enterprise system and the dial-in client system, making the secure remote access delivery system described here a relatively secure and safe method of communication between a dial-in user and a destination enterprise system. It is anticipated that a VSPOP system as described here will be able to facilitate communication between multiple enterprise destination systems and each enterprise's dial-in users, and may include multiple or redundant VSPOP facilities.

Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the invention. It is intended that this invention be limited only by the claims, and the full scope of equivalents thereof.

1. A method of providing secure dial-in access to an enterprise system over a public network via a Virtual Secure Point of Presence (VSPOP), comprising:
receiving a dial-in user connection in a VSPOP;
authenticating the user connection via the VSPOP; and
providing an encrypted connection from the received dial-in connection in the VSPOP to the enterprise system over a public network.
*define VSPOP in spec carefully . . .

2. The method of claim 1, wherein the dial-in user connection comprises a dial-in connection via a local exchange carrier bypass trunk.
*define lec bypass trunk in spec

3. The method of claim 1, wherein the dial-in user connection comprises a toll-free dial-in connection.

4. The method of claim 1, wherein the public network is the Internet.

5. The method of claim 1, wherein the VSPOP is operable to provide a connection to multiple enterprise systems.

6. The method of claim 1, further comprising tracking the dial-in user connection and storing resulting tracking data in a log.

7. The method of claim 6, wherein the logged tracking data is used for accounting.

8. The method of claim 1, wherein authenticating the user connection via the VSPOP comprises authorizing facilitating a connection between the dial-in user and the enterprise system.

9. The method of claim 1, wherein authenticating the user connection via the VSPOP comprises user authentication via an authentication service provided by the VSPOP.

10. The method of claim 9, wherein the authentication service provided by the VSPOP is a Remote Authentication Dial-In User Service (RADIUS).

11. The method of claim 1, wherein authenticating the user connection via the VSPOP comprises user authentication via an authentication service provided by the enterprise system.

12. The method of claim 11, wherein the authentication service provided by the enterprise system is a Remote Authentication Dial-In User Service (RADIUS).

13. The method of claim 1, wherein the encrypted connection from the VSPOP to the enterprise system comprises a IPsec connection

14. The method of claim 1, wherein the encrypted connection from the VSPOP to the enterprise system comprises a Layer 2 Forwarding (L2F) connection.

15. The method of claim 1, wherein the encrypted connection from the VSPOP to the enterprise system comprises a PPTP connection.

16. A machine-readable medium with instructions stored thereon, the instructions when executed operable to cause a computerized system to provide secure dial-in access to an enterprise system over a public network by:
receiving a dial-in user connection in a Virtual Secure Point of Presence (VSPOP);
authenticating the user connection via the VSPOP; and
providing an encrypted connection from the received dial-in connection in the VSPOP to the enterprise system over a public network.

17. The machine-readable medium of claim 16, wherein the dial-in user connection comprises a dial-in connection via a local exchange carrier bypass trunk.

18. The machine-readable medium of claim 16, wherein the dial-in user connection comprises a toll-free dial-in connection.

19. The machine-readable medium of claim 16, wherein the public network is the Internet.

20. The machine-readable medium of claim 16, wherein the VSPOP is operable to provide a connection to multiple enterprise systems.

21. The machine-readable medium of claim 16, the instructions further operable to cause the computerized system to track the dial-in user connection and store resulting tracking data in a log.

22. The machine-readable medium of claim 21, wherein the logged tracking data is used for accounting.

23. The machine-readable medium of claim 16, wherein authenticating the user connection via the VSPOP comprises authorizing facilitating a connection between the dial-in user and the enterprise system.

24. The machine-readable medium of claim 16, wherein authenticating the user connection via the VSPOP comprises user authentication via an authentication service provided by the VSPOP.

25. The machine-readable medium of claim 24, wherein the authentication service provided by the VSPOP is a Remote Authentication Dial-In User Service (RADIUS).

26. The machine-readable medium of claim 16, wherein authenticating the user connection via the VSPOP comprises user authentication via an authentication service provided by the enterprise system.

27. The machine-readable medium of claim 26, wherein the authentication service provided by the enterprise system is a Remote Authentication Dial-In User Service (RADIUS).

28. The machine-readable medium of claim 16, wherein the encrypted connection from the VSPOP to the enterprise system comprises a IPsec connection

29. The machine-readable medium of claim 16, wherein the encrypted connection from the VSPOP to the enterprise system comprises a Layer 2 Forwarding (L2F) connection.

30. The machine-readable medium of claim 16, wherein the encrypted connection from the VSPOP to the enterprise system comprises a PPTP connection.
MRM claims

31. A Virtual Secure Point of Presence (VSPOP) computerized system operable to provide secure dial-in access over a public network by:
receiving a dial-in user connection in a VSPOP;
authenticating the user connection via the VSPOP; and
providing an encrypted connection from the received dial-in connection in the VSPOP to the enterprise system over a public network.

32. The computerized system of claim 31, wherein the dial-in user connection comprises a dial-in connection via a local exchange carrier bypass trunk.

33. The computerized system of claim 31, wherein the dial-in user connection comprises a toll-free dial-in connection.

34. The computerized system of claim 31, wherein the public network is the Internet.

35. The computerized system of claim 31, wherein the VSPOP is operable to provide a connection to multiple enterprise systems.

36. The computerized system of claim 31, further operable to track the dial-in user connection and store resulting tracking data in a log.

37. The computerized system of claim 36, wherein the logged tracking data is used for accounting.

38. The computerized system of claim 31, wherein authenticating the user connection via the VSPOP comprises authorizing facilitating a connection between the dial-in user and the enterprise system.

39. The computerized system of claim 31, wherein authenticating the user connection via the VSPOP comprises user authentication via an authentication service provided by the VSPOP.

40. The computerized system of claim 39, wherein the authentication service provided by the VSPOP is a Remote Authentication Dial-In User Service (RADIUS).

41. The computerized system of claim 31, wherein authenticating the user connection via the VSPOP comprises user authentication via an authentication service provided by the enterprise system.

42. The computerized system of claim 41, wherein the authentication service provided by the enterprise system is a Remote Authentication Dial-In User Service (RADIUS).

43. The computerized system of claim 31, wherein the encrypted connection from the VSPOP to the enterprise system comprises a IPsec connection

44. The computerized system of claim 31, wherein the encrypted connection from the VSPOP to the enterprise system comprises a Layer 2 Forwarding (L2F) connection.

45. The computerized system of claim 31, wherein the encrypted connection from the VSPOP to the enterprise system comprises a PPTP connection.
